(19) United States
(12) Patent Application Publication
(10) Pub. No.: US 2003/0101076 A1
(43) Pub. Date: May 29, 2003

(54) System for supporting clinical decision making through the modeling of acquired patient medical information

(76) Inventor: John R. Zaleski, West Brandywine, PA (US)

Correspondence Address: Siemens Corporation, Intellectual Property Department, 186 Wood Avenue South, Iselin, NJ, 08830, US

(21) Appl. No.: 10/247,711

(22) Filed: Sep. 19, 2002

Related U.S. Application Data
(60) Provisional application No. 60/326,624, filed on Oct. 2, 2001.

(51) Int. Cl. G06F 17/60

(52) U.S. Cl. 705/2

(57) ABSTRACT

The present invention is directed therefore to a system for supporting clinical decision-making based on acquired patient data. The system preferably includes a data repository for storing accumulated medical information associated with a plurality of medical conditions and at least a portion of the acquired patient data; a data analyzer programmed to identify a pattern in the acquired patient data; and a user interface for transmitting the pattern to a user. This may be achieved using a computer program incorporating a data server programmed to receive the acquired patient data and accumulated medical information; a data analyzer programmed to identify a pattern in the acquired patient data based upon at least a portion of the acquired patient data and the accumulated medical information; and a user server programmed to transmit the identified pattern to a user. In operation, the present invention receives the accumulated medical information and acquired patient data; analyzes at least a portion of the acquired patient data and accumulated medical information to predict a pattern therein by generating a mathematical model; and transmits the identified pattern to a user.

This application claims priority to U.S. Provisional application Serial No. 60/326,624 by John R. Zaleski, filed Oct. 2, 2001 entitled “A System for Processing healthcare claim Data.”

### BACKGROUND OF THE INVENTION

1. Field of the Invention

The present invention is directed to a system for analyzing healthcare data. More particularly, the present invention is directed to a method and apparatus for analyzing individual patient medical information, including telemetry from acute care modalities, and statistical clinical data from a remote system using a computer network.

2. Description of the Prior Art

Accurately predicting future medical conditions of individual patients and patient groups is a capability essential to the basic functioning of human lives. These predictions enable hospital administrators to manage the quantity and type of staff they have in-house and the quantity of beds to maintain. At the departmental level, accurate prediction can be a powerful aid to the frontline clinician to provide better patient care management. An advantage of these predictions is to estimate with as high a degree of accuracy as possible the expected outcome, such that the estimated result will match the actual result, once the actual result occurs. The accuracy of the predictions is, of course, dependent upon many factors. Some of these factors include the accuracy of the models used to predict the future events, the amount and fidelity of information these models are based on, and the length of time into the future the prediction has been projected.

In terms of a healthcare model, one can choose to define the qualitative term “better” as the ability to more accurately predict patient outcomes and future events so as to more effectively apply the talents of the clinical staff to meet the needs of the patient. Meeting the needs of the patient can take on many forms, from more responsive bedside delivery of care to intervention prior to the onset of an event (such as myocardial infarction). The ability to anticipate or notice the symptoms indicative of a particular event prior to the event occurring can translate into more effective patient care management from several perspectives.

Recognizing and acting on symptoms before an event occurs translates into less strain, discomfort, and complications experienced by the patient. Moreover, intervening in patient care before any negative event occurs translates into mitigating the need for supplemental staff and treatment modalities that result in added healthcare costs. Accurately assessing which patients need specific treatment at some specific time enables scheduling and allocating healthcare staff to where they are needed most.

The value of using predictive methodologies in medicine to assess the likelihood of future events is demonstrated implicitly in medicine's ability to successfully treat and manage patients with all forms of ailments. In fact, administering vaccines or drugs at specific dosages is employing a form of prediction: for a model of expected behavior had to be determined, validated, and verified prior to applying a specific drug or treatment modality to a new patient experiencing similar symptoms.

The use of predictive methodologies in the form of mathematical relationships and models to forecast expected behavior, or derive relationships from seemingly uncorrelated data, is itself well known in the art. Such use is described, for example, in Andreas S. Weigand & Neil Gershenfeld, Editors, Time Series Prediction: Forecasting the Future and Understanding the Past. Addison-Wesley, 1994. However, the conventional modeling systems of the prior art are unable to generalize these mathematical relationships in a form that is convenient to use clinically; that does not require specialized knowledge of mathematics and statistics to build upon; and that can apply across a wide-spectrum of possible clinical and non-clinical applications.

Most clinical data presentation and mining/analysis tools such as HP CareVue™ or APACHE Medical Systems' Discover+ DSS Tools, or data exploitation tools such as Data Critical's unWiredDr™, provide charting and analysis capability for clinical data. These systems are clinical-information systems deployed at the point of care to support a multidisciplinary, collaborative approach to patient care management. They enable clinicians to configure comprehensive reports; gather clinical data; and allow departments to analyze utilizations and perform research. They also provide enhanced reporting, charting and analysis, as well as enhanced security and new clinical-notes-filtering capabilities.

Unfortunately, however, these systems do not provide a convenient way to perform complex comparative trend analysis of data and cannot provide access by multiple remote interfaces of different types over a single communication system, such as the Internet. Accordingly, a more efficient system is needed that is capable of acting as the foundation on which to establish predictive methodologies for clinical application that would provide significant advantages in the process of defining a truly valuable decision support system for the clinician.

### SUMMARY OF THE INVENTION

The present invention is directed therefore to a system for supporting clinical decision-making based on acquired patient data. The system preferably includes a data repository for storing accumulated medical information associated with a plurality of medical conditions and at least a portion of the acquired patient data; a data analyzer programmed to identify a pattern in the acquired patient data; and a user interface for transmitting the pattern to a user. This may be achieved using a computer program incorporating a data server designed to receive the acquired patient data and accumulated medical information; a data analyzer programmed to identify a pattern in the acquired patient data based upon at least a portion of the acquired patient data and the accumulated medical information; and a user server programmed to transmit the identified pattern to a user. In operation, the present invention receives the accumulated medical information and acquired patient data; analyzes at least a portion of the acquired patient data and accumulated medical information to predict a pattern therein by generating a mathematical model; and transmits the identified pattern to a user.

### BRIEF DESCRIPTION OF THE DRAWINGS

FIG. 1 is a diagram of a preferred embodiment of the system of the present invention.

FIG. 2 is a visual representation of a modeling of a patient chart in the preferred embodiment of the present invention illustrating a power series model derived using the method of least squares.

FIG. 3 is a computer screen shot of a user profile input form in a preferred embodiment of the present invention.

FIG. 4 is a computer screen shot of a trend analysis form of a preferred embodiment of the present invention.

FIG. 5 is a visual representation of the computation of the time of re-occurrence of a signal anomaly or desired signal on an ongoing best-fit pattern recognition methodology in the preferred embodiment of the invention.

FIG. 6 is a chart illustrating the least squares filtering of the preferred embodiment of the invention.

FIG. 7 is a computer screen shot of a signal selection in the user interface of the preferred embodiment of the invention.

FIG. 8 is a computer screen shot of a graphical display of a computed trend in the user interface of a preferred embodiment of the invention.

FIG. 9 is a computer screen shot illustrating an initial entry screen, completed upon arrival from surgery, used in the preferred embodiment of the present invention.

FIGS. 10(a)-(b) are computer screen shots of a post-submission screen of a preferred embodiment of the present invention.

FIG. 11 is a computer screen shot of a capillary wedge pressure plot for a patient displayed in the user interface of the preferred embodiment of the invention.

FIG. 12 is a computer screen shot of a heart rate plot for a patient displayed in the user interface of the preferred embodiment of the invention.

FIG. 13 is a computer screen shot of a stroke volume plot for a patient displayed in the user interface of the preferred embodiment of the invention.

FIG. 14 is a computer screen shot of a plot of Forced Expiratory Volume over 1 second for a patient displayed in the user interface of the preferred embodiment of the invention.

FIG. 15 is a computer screen shot of a plot of a least squares prediction overlaid on patient data displayed in the user interface of the preferred embodiment of the invention.

FIG. 16 is a flow diagram illustrating a proposed functional interface in the preferred embodiment between the Repository housing the knowledge & model data and the Data Extraction functionality.

### DETAILED DESCRIPTION OF THE PREFERRED EMBODIMENTS

The present invention will be understood more fully from the detailed description given below and from the accompanying drawings of preferred embodiments of the invention; which, however, should not be taken to limit the invention to a specific embodiment but are for explanation and understanding only.

The system of the present invention enables a front-line healthcare provider or healthcare researcher to study the frequency, trends, and behavior of healthcare data. Data can include clinical and non-clinical information, such as patient respiratory, ECG, and EEG signals or disease trends, treatment and population studies. The system operation involves collecting raw data from existing patient databases, monitors, and other collection modalities. The system prompts the user to then selectively identify patterns of behavior from said data. These patterns are electronically stored in a repository where they can then be made available for future study against test data.

These stored data patterns enable a user to select any type of signal pattern or anomaly from the test data source and to study the frequency of occurrence of this anomaly within the source, establish a track (estimate) of when the next event is likely to occur, and to store these anomalies in an on-line repository that holds personalized user information as to the types of signal anomalies to be considered for a given class of patients and/or patient problems. The repository allows for continuous growth, so a collection of anomalistic models can be archived and used across (potentially) multiple providers at multiple locations.

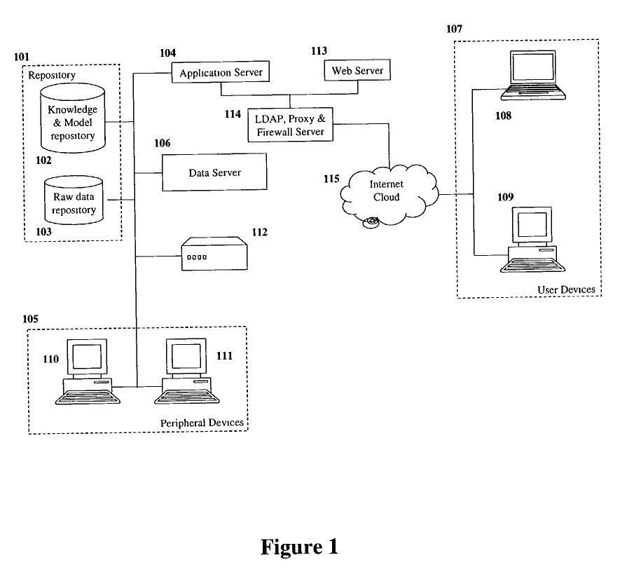

FIG. 1 is a diagram of a preferred embodiment of the apparatus used in the present invention. As shown in FIG. 1, the system of the present invention is preferably implemented in computer hardware and software configured to operate on a dedicated software application and Web-enabled hardware computing system to access raw medical facts about patients extracted from lifetime clinical records and telemetry from available modalities (such as ventilators, pulse oximeters, ECG monitors, core temperature probes, etc.); and to convert this raw data into mathematical models for clinical outcome and real-time patient state prediction. Those of ordinary skill in the art will appreciate that the embodiment of the system shown here is provided with the intent of demonstrating a clear understanding of the potential capabilities of the system and not to limit the scope or possible embodiments of the invention.

The raw facts may include, for example, (LCR) databases, clinical hardware modalities (including mechanical ventilators, heart rate monitors, home health monitors, oxygenation monitors, temperature monitors) that provide information such as patient identity, demographics, physiological information, the length of stay, amount and variety of administered medication, types of procedures, patient body mass, blood gas, gender, height, ailment & treatment information; and raw respiratory & cardiovascular information, etc. This data may be stored and retrieved in any number of well-known formats, such as ASCII.

As shown in FIG. 1, the system may include a Data Repository 101, which may include, as one embodiment, a Knowledge and Model Repository 102 for maintaining historical trending and best-fit model information on patients, organized according to patient parameters (including but not limited to gender, mass, body surface area) and a Raw Data Repository (RDR) 103 for retaining monitored ECG signals, patient core temperature, hemodynamic data (including cardiac output or index), and respiratory parameters (including but not limited to respiratory rate, tidal volume, inspired oxygen fraction, positive end expiratory pressure). These data repositories may comprise any of a number of data storage systems that are well known to those of skill in the art, such as relational databases including SQLServer 2000, Oracle, DB2, or MS Access.

The system may also include Application Server 104 containing software processes capable of extracting, profiling, predicting, and trending signal behavior based on historical behavior as recorded within KMR 102; as well as a User Interface Process (UIP) for tailoring output from the system to the visual needs of the user, and a Signal Selection Process (SSP) that enables the user to dynamically select portions of signals collected in real-time from patients for hypothesis testing. These signal portions are capable of being stored in KMR 102 where they can be searched and applied at will to test the similarity of newly collected signals against these models.

The receipt of the raw data is preferably accomplished through the use of tailored hardware and software peripheral devices (e.g. software interfaces relative to the LCR; hardware interfaces and software interfaces relative to monitoring modalities), shown in FIG. 1 as Peripheral Devices 105 and Machine Specific Interface 112, which provide information to Data Server 106. Peripheral Devices 105 and Machine Specific Interface 112 may communicate with Data Server 106 in any number of ways well known to those of ordinary skill in the art, such as through the use of conventional interface electrical cabling between the system of the present invention and departmental hardware modalities. The software for supporting the extraction of the data per specific modality is preferably stored locally within the system, such as on Data Server 106, and is applied to each specific modality as needed to extract raw medical facts.

The raw medical facts are preferably converted by the peripheral devices into information contained within an Extensible Markup Language (XML) format, received by Data Server 106 and stored according to patient demographics stored within Repository 101. Alternatively, Data Server 106 could receive this information in its native format and convert it to XML.

The raw facts, once stored, are preferably binned according to patient demographics in a conventional manner. The facts are then analyzed by the software of the present invention to identify relationships among their base elements. These relationships are preferably captured in the form of mathematical models and statistical distributions relating the degree to which a given model approximates the behavior of a given pairing of demographics. Together, the statistical distributions and associated mathematical models are preferably then stored as weights within a Probabilistic Neural Network (PNN). The operation of PNN's generally are well known to those of skill in the art. For example, the operation of PNN's is discussed in detail by Wasserman in Advanced Methods in Neural Computing, van Nostrand Reinhold, 1993. As more data become available, these models and distributions are refined automatically. These refined models and distributions result in updated classifiers, stored within the PNN. The process of continuing improvement results in improved levels of predictability, owing to the PNN's ability to capture and represent more degrees of freedom associated with the increased quantity of raw facts.

In one preferred embodiment, the data are binned by patient characteristics, such as gender, mass, height, age, ailment, and medication regimen. Independent and dependent variable relationships are identified by use and are stored together with the data. The bins may preferably be used to create mathematical models and associated correlations using methods of least squares regression. These mathematical models are stored according to each bin with associated correlation coefficients. Statistics in the form of multivariate covariance matrices are developed for each model in comparison with the raw data. Together, these matrices and mathematical models are used to create distribution shape functions that are stored in the form of a PNN method. The PNN, in turn may be stored within Repository 101, which also contains the raw patient data that is used in processing the weights associated with the PNN method.

The raw patient test data (associated with a patient whose resultant medical outcome is to be predicted) may also be used to extract the appropriate mathematical models whose coefficients are stored in the PNN method. Once determined automatically by the PNN, the mathematical model is used to produce an outcome result (dependent variables) from the input parameters identified for a specific patient in question (independent variables). A predicted mathematical result (dependent variables) is produced and reported to the user. This independent input data (from the raw patient test data) may be fed back into the system, where it is used to refine the current instantiation of mathematical models representing patient outcome. The statistical distributions and mathematical models associated with binned correlations result in refined estimates of the weights (least squares coefficients) employed by the PNN, and are preferably stored for later use by either this present test patient or some other patient.

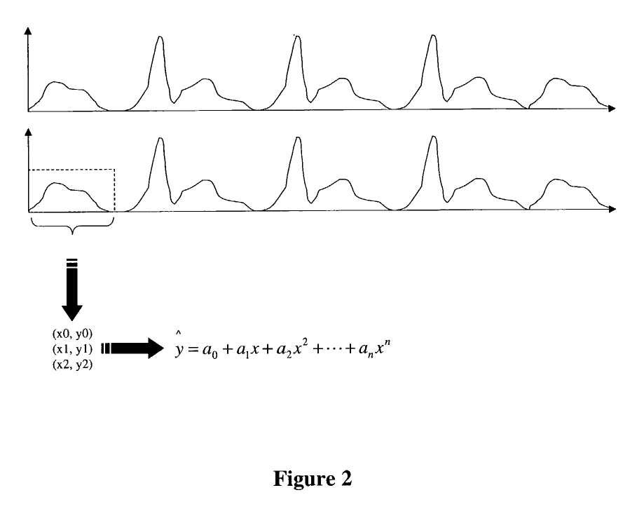

Using this application, raw patient telemetry data are acquired for a patient, such as through the aforementioned CareVue™ system. Using User Interface 107, a clinician may then mark an anomaly or event for further study, such as by windowing the entire signal or selecting any portion of signal using a mouse or palm stylus. The software process then pulls raw data coordinates from windowed signal and builds a least squares model of the signal segment. The least squares model is not particularly limited, but is preferably based on minimum chi-squared criteria between model and raw signal. Coefficients for the model are preferably stored in Knowledge and Model Repository 102. The coefficients provide a representation of the patient signal segment. This is illustrated visually in FIG. 2 for a hypothetical chart of patient information.

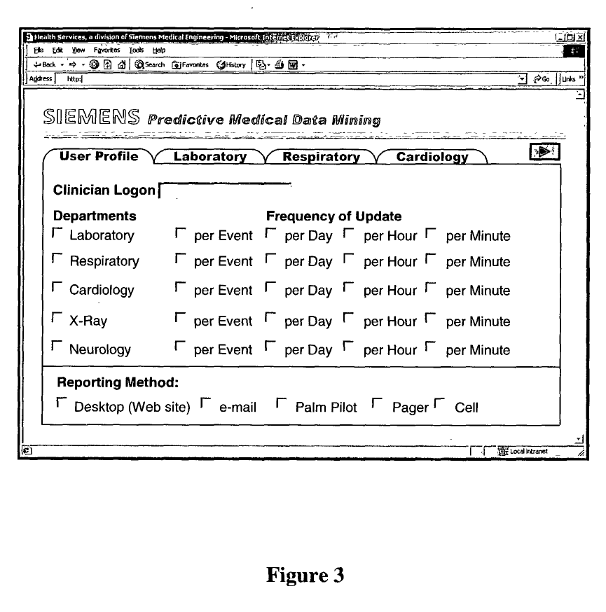

These coefficients are then identified as associated with a patient user model, which is stored with a pointer from a user profile established by the user. Using User Interface 107, the user may specify a variety of information in this user profile, such as the frequency with which comparisons of the model to the raw data are to be made; the types of signal telemetry data that are to be considered; the number of profiles to be generated, per signal type; patients on which data are to be collected; and profiles on previously stored patients with which current patients are to be compared. The user profile enables a clinician to specify the type of data requested remotely, the frequency of update, per event, etc. User Interface 107 is preferably used to both request the specific type(s) of output to be pushed to the user and to plot the data on the specific device (e.g., palm pilot, laptop). Depending on reporting method chosen, the system would then provide access to specific reporting tools. An example of the input form for accomplishing this is illustrated in FIG. 3.

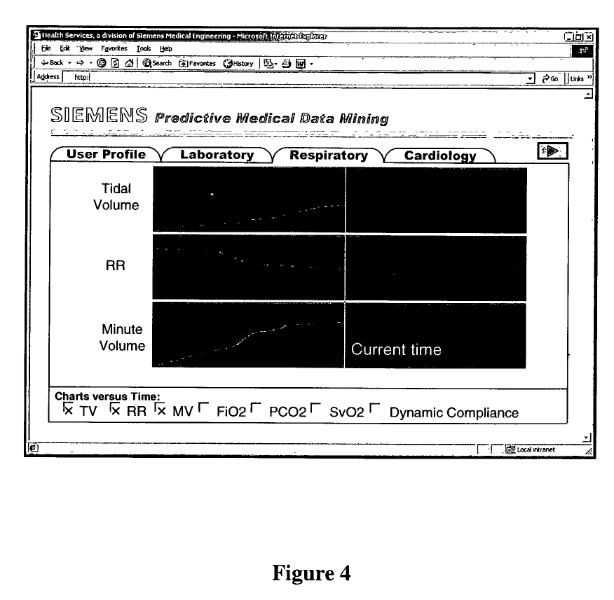

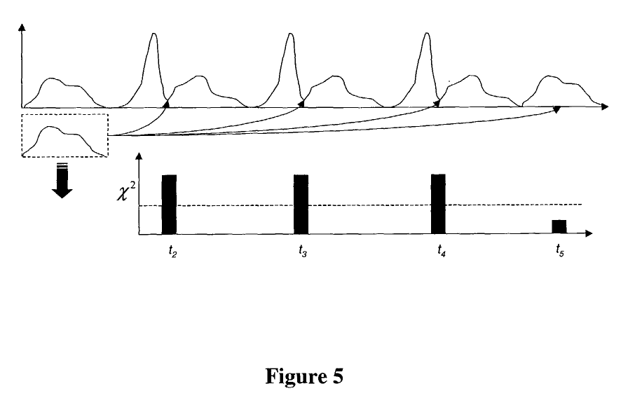

Trending and forms tools may be used to display the raw signals or to window on a particular piece of data for analysis of frequency of occurrence. See, for example, FIG. 4. The least-squares comparison between models and raw signal data is preferably performed according to the modified Mahalanobis distance calculation below:

$${χ}_{ij}^{2} {= \sum }_{i} {\sum }_{j} {( {\hat{y}}_{i} - {y}_{j} )}^{2}$$

where i is a subscript on model value y based on the model equations evaluated at xi and j is a subscript on raw data value y extracted at xj.

As the number of user model classes increases, a class comparison is preferably performed to determine the best match between a specific model to the signal. Patient models are typically stored in Knowledge and Model Repository 102 in a form such as: User_{—}1_M1, User_{—}1_M2, . . . User_N_Mm. The model is thereby associated with a particular user, and the model numbers are contained within that user profile. The model is then calculated and compared against the raw patient data and a minimal and optimal best fit χ² is selected for the model, e.g. Model, U_*_M_*.

The time of re-occurrence of a signal anomaly or desired signal behavior is thus preferably computed, stored, and presented to user based on an ongoing best-fit pattern recognition methodology as illustrated in FIG. 5. The first occurrence of the event at time t₁ becomes the model. Subsequent comparisons yield various χ² values. The χ² acceptability threshold can be user specified or based heuristically on historical data. The sample frequency of the occurrence of the anomaly is preferably determined based on a reciprocal of the time difference between occurrences of the anomaly, e.g.:

$${f}_{1} = \frac{1}{{t}_{5} - {t}_{1}}$$

The benefit of this approach over others, such as the Lomb Periodogram approach, is that the method of the present invention finds the frequency of specific pattern behavior.

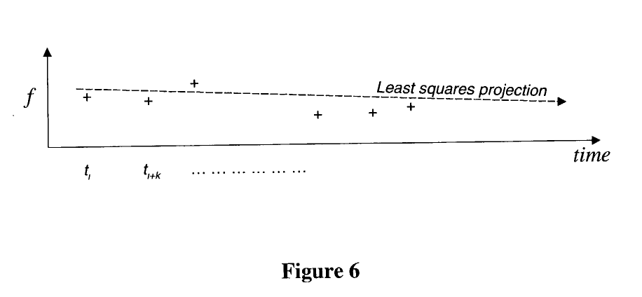

Continued monitoring results in repeated estimates of the frequency of the event, which can be tracked in the least-squares sense using a batch or Kalman filter. This is illustrated in FIG. 6.

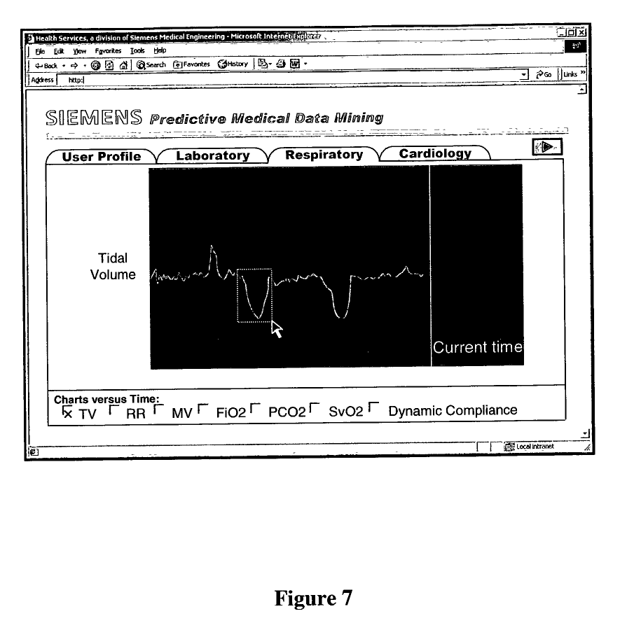

User may window on desired portion of signal, as shown in FIG. 7. Windowed coordinates would be sent back to Application Server 104 to be processed. Model would be stored automatically in Knowledge and Model Repository 104. The above describe analysis would preferably proceed automatically on Application Server 104 using the patient data provided from Raw Data Repository 103 and the patient's model information stored in Knowledge and Model Repository 102.

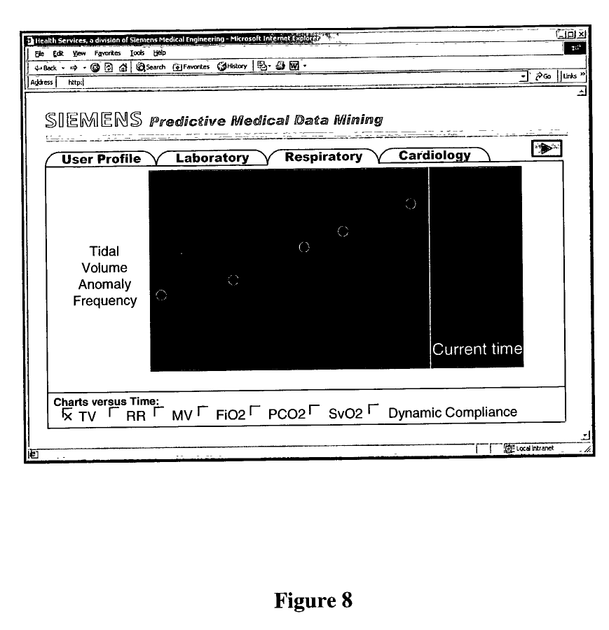

The ongoing results of the analysis (e.g. the trend) may then be transmitted by Application Server 104 back to User Interface 105, such as in the form of a graphical display that is updated in real time (although not limited thereto). An example is shown in FIG. 8. The chart indicates a potentially important trend may be occurring which may require intervention (for example, increased shortness of breath,)

If a physician is reviewing some clinical data on a patient, the physician may pull up the data and requested a plot of the history (suppose a history of a particular patient response or anomaly in, say, respiratory rate is desired, or a history of ST segment length, or a history of drug use, or a history of weight). The physician may then apply a model to show the trend of this history over time. The trend and the historical data may be stored in a data repository and made available (that is, published) to all others who have access to the system, even physicians who are located remotely. The analyzed patient data could even form a template for future normalization determinations (that is, comparison in a least-squares sense with other patients). This would enable a physician to have a real-time assessment of the particular parameters for a specified patient in comparison to an historical record. As more historical data become available, a refined probabilistic representation of the information may be updated.

A clinician, researcher, or health care provider may then exercise hypothesis tools using the present invention to predict whether a given patient is likely to experience a given outcome (either as the result of a treatment, or as a consequence of the patient's particular demographics in comparison with historical data). The patient is preferably compared statistically with others having similar demographic and treatment characteristics. The degree of similarity between a patient's demographic characteristics is determined from the PNN, and a prediction of likelihood of the occurrence of the hypothesized event is made. The result is preferably reported to the clinician via one of the devices of User Interface 105, and the patient's data are then incorporated into the historical portion of Repository 101 for future hypothesis testing with either this or other patients. In addition, the chosen outcome of the health care provider may also be stored within the system so that a statistic on the choice of treatment is maintained and reported to the health care provider in addition to the expected patient response.

In order to promote a broader understanding of how effective prediction using the system of the present invention can improve patient care management, several examples are identified and used as sources for guiding some of the predictive methods discussed herein. These examples will aid in the visualization and understanding of the application of predictive techniques and concepts presented herein.

### EXAMPLE 1

Hemodynamic parameters and the implementation of a model to demonstrate how they may be used as a clinical predictor. Patients within acute care or intensive care units who are recovering from invasive surgeries such as coronary artery bypass grafting (CABG) are monitored for signs of cardiac pump failure. Signs leading to early recognition of heart failure are described, by Paul Marino, The ICU Book, 2d Edition, page 244, Williams & Wilkins, 1998, are summarized below in the typical order in which they occur: 1) Increased pulmonary capillary wedge pressure (CWP); 2) Decreased stroke volume (SV) followed by an increase in heart rate (HR); and, 3) Decreasing cardiac output (CO), marking the transition from compensated to de-compensated heart failure.

Increase in wedge pressure occurs prior to a noticeable decrease in stroke volume. However, at the point at which stroke volume begins to decrease, initial compensation for decreased blood volume is achieved through an increase in heart rate, resulting in maintaining an approximately constant cardiac output, according to the following expression: CO=SV×HR. Thus, the monitoring of the cardiac filling pressures and stroke volume are early indicators of heart failure. While specific values for an individual patient can vary, normal ranges of these parameters are somewhat defined by patient physiology, demographics, and general health. A comparison between an individual patient's performance with a larger population can lead to an indicator of the degree of agreement between, say, normal values CWP, SV, and HR and abnormal values of the same parameters. Thus, in addition to clinical knowledge of the cardiovascular system and its function, having historical knowledge indicative of the general “trajectory” of serial behavior leading to warning signs can provide the clinician with information as to what patient presentations will require corrective action.

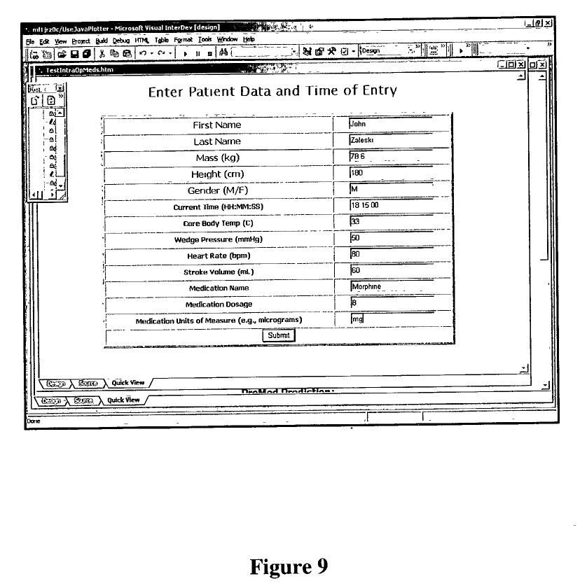

This relationship is illustrated in FIG. 9 for a single patient. Marino describes histories of patient filling pressure and stroke volume for a population of patients, normalized by patient gender, body surface area, and age, then, by correlating the postoperative features of a given “test” patient with these parameters, a given patient's “trajectory” may evolve either according to an acceptable path, or is headed towards potential failure.

While this model is simplistic, the larger implications from the clinical decision support perspective are important: early intervention, tied to probabilistic events based on historical populations that provide indications of failure or success (or some degree in between).

The model (expected) trajectories are compared with the measured (actual) trajectories of the patient. The comparison is evaluated to determine the degree of “likeness” or “sameness” between the expected and actual trajectories. Finally, by combining all trajectories together, it is possible to determine a cumulative estimate of “sameness” using a χ²-square test to show that the patient's cardiovascular parameters are either following or not following an expected path (one leading towards possible trouble).

Comparison of the instantaneous values of these three parameters with the modeled values (that is, single values at a given time) reduces the effectiveness of the result because all of the historical data defining the value up to the current time are omitted from the calculations. One could apply the χ²-square statistic to an instantaneous sampling of the patient data as compared with the expected parameters. In this case, for example, one could compare the instantaneous measurement of CWP, HR, and SV with the modeled values associated with a particular instant in time. This can be visualized in Table 1 below for a sample set of patient data. The type of question to be answered with this evaluation might be “Given the efficacy of the model data, how closely are this patient's hemodynamic parameters correlated to it?” In this example, though, there is a relatively small sample size. Therefore, for such cases, Fisher's exact probability test would be appropriate (as described, for example, in James F. Zolman, Biostatistics: Experimental Design and Statistical Inference. Oxford University Press, 1993. Furthermore, it would be difficult to determine whether the instantaneous values were indicative of a specific problem, as the trajectories themselves provide information related to the specific trends of these parameters. Hence, as can be seen in Table 1, even though the actual parameters are within 5-10 units of the modeled values, the χ-square statistic indicates relatively poor correlation.

TABLE 1
Comparison between the instantaneous values of actual
versus modeled parameters indicative of post-operative
heart failure.

| | Acutal values | Expected values associated |
|---|---|---|
| Time = 60 minutes | measured at | with heart failure |
| postoperatively | this time | at this time |
| CWP (mmHg) | 20 | 25 |
| HR (bpm) | 80 | 75 |
| SV (mL) | 60 | 65 |

| | |
|---|---|
| χ-square test statistic: | 1.72, n = 2 degrees of freedom |

Thus, employing a model of the parameters offers the benefit of defining both the character of the data (its trajectory over time) and the specific values indicative of success, failure, or degrees in between the two categories.

### EXAMPLE 2

A decision support tool to illustrate whether a patient has a similar presentation as that of a specific model. Chronic obstructive pulmonary disease (COPD), including emphysema and chronic bronchitis, is a disorder characterized by varying degrees of airflow, as measured by spirometry. At present, the annual estimated cost to the U.S. taxpayer for COPD treatment and related expenditures is $30.4B, and constitutes the fourth leading cause of death, claiming (as of January 2001) 107,146 Americans annually. Patients with COPD typically have reduced FEV₁ response, and reduced FEV₁-to-forced-vital-capacity (FVC) ratio on pulmonary function tests. Furthermore, while FVC tests approach normality with mild COPD, FVC degrades as COPD progresses. A more detailed discussion of this disorder can be found in William N. Kelley, Editor-in-Chief, Essentials of Internal Medicine, J. B. Lippincott Company, 1994 and “American Lung Association Fact Sheet: Chronic Obstructive Pulmonary Disease (COPD).” January 2001.

Forced expiration curves are reproducible, since at every lung volume there exists a maximal rate of flow that cannot be exceeded; a detailed discussion of which can be found in “Johns Hopkins School of Medicine's Interactive Respiratory Physiology,” located at <http://omie.med.jhmi.edu/res_phys/Encyclopedia/ForcedExpiration/ForcedExpiration.html>. Hence, these data provide the basis for comparison with large patient populations to determine, over the course of a patient's treatment (which can be managed over a lifetime) whether a patient's respiratory condition is evolving normally or is degenerating.

Database Server 106 is fed in a conventional manner, such as a client/server architecture operating over a computer network (e.g. Web Server 113, Firewall 114, and Internet Cloud 115), with intra-operative data, post-operative data, and clinical data via several peripheral devices as described below. As these data are collected, they are continually stored and used as bases of comparison with other patients to test hypotheses about said patients. These data may be stored in Repository 101 via Data Server 106 that retrieves these data from a variety of sources.

One such source of information on the patient is Anesthesiologist Workstation 110, preferably located within the operating room. Anesthesiologist Workstation 110 may be, for example, a conventional personal computer running software, such as a Web browser or other thin-client type of software, e.g. using active or java-server-page (ASP/JSP) based forms, which allows it to communicate with Database Server 106 in a conventional manner. Anesthesiologist Workstation 110 provides the user with a user screen for retrieving amounts of patient medications administered at specific times during the operative procedure, together with commentary (textual data) on the status of the procedure as time progresses. A sample of such an input form is illustrated in FIG. 9.

As discussed earlier in the example on heart failure, information regarding patient anesthetic agents, sedatives, antifibrinolytic agents, and other information can be recorded and supplied to Repository 101 for later analysis, model building, and future model-patient comparison usage. For example, candidate anesthetics such as fentanyl are typically administered in dosages of 5-10 μg/kg (micrograms per kilogram) for induction. Midazolam and Pancuronium can be administered as sedatives and paralyzers, respectively, prior to performing invasive procedures (such as bypass grafts). The collection of this information can be useful, for example, to estimate how quickly and appropriately a patient can be weaned from the effects of mechanical ventilation during recovery. These data are preferably inputted by the anesthesiologist or nurse using Anesthesiologist Workstation 110 while in the operating room. These data is stored in Repository 101 and is available later in electronic format, together with stored models of patient response, with which patient performance can be correlated.

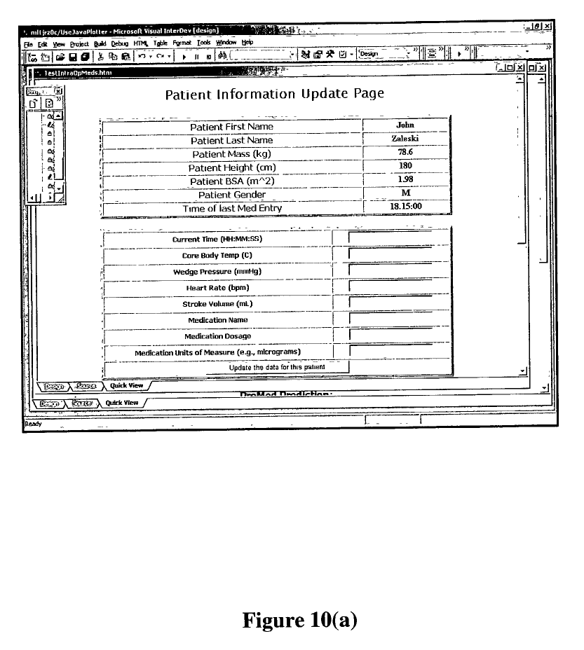

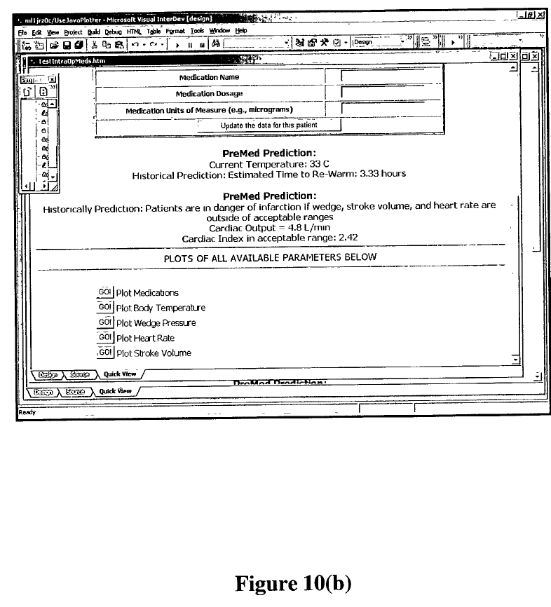

Another source of information to Data Server 106 represents laboratory data associated with such patient information as blood pH levels, hemoglobin content, Calcium, Potassium, Sodium, and partial CO2 pressure. Laboratory data are preferably entered via Laboratory Workstation 111. A server process preferably located at the Data Server 106 also formats this data, which again may be transmitted to Data Server 106 in XML format, and stores this information by patient in Repository 101. While not meant to be limiting, FIGS. 10(a) and (b) illustrate examples of the scope of the data available from this patient on an input screen of the client software operating on Laboratory Workstation 111.

Pressing the submit button logs this patient's data as a new entry. A clinician is able to recall a patient's specific information by selecting specific objects extracted from Repository 101 in a visual format. This format permits the user to drill down specific data objects, and to study and hypothesize on the impacts of each tier (intra-operative, post-operative) on the tier immediately preceding/following it. Data charting functions available within the server processes then enable a user to select specific items for study, as shown.

In addition, patient respiratory and cardiovascular data may be supplied via Machine-Specific Interfaces 112 to the Data Server 106. These interfaces may include cable connectors tailored for specific brands of cardiovascular and respiratory machinery; for example, HP CareVue monitors, Siemens monitors, Mallinckrodt Mechanical Ventilators, and Siemens Mechanical Ventilators. The cardiovascular data may be retrieved by a polling process that retrieves cardiovascular data from the available monitors (for example, HP CareVue monitors and mechanical ventilators) using appropriate interface hardware and software designed to extract said information from the monitors. This data preferably includes heart rate, arterial blood pressure, core body temperature, SpO2 level, respiratory rate, tidal volume, minute volume, inspired oxygen fraction, mean airway pressure, positive end expiratory pressure, and ventilator mode.

Upon retrieving the raw data, a server process (e.g. a computer program) preferably located on Application Server 104, although not limited thereto, formats and tags each data element with a time tag and stores these elements in tables (such as respiratory, laboratory, and cardiovascular) maintained within Repository 101. This data is preferably stored using a server process located on Database Server 106. For example, the data may be transmitted to Data Server 106 in Extensible Markup Language (XML) format describing the patient ID, name, medications, time of medication administrations, and commentary, together with the automated cardiovascular and respiratory data. The data is then stored within data repository in a conventional manner to identify the patient by name, age, gender, mass, and height. Repository 101 is directly accessible by Data Server 106.

As an example visualization of the available data, FIG. 9 illustrates a preferred embodiment of a startup page associated with the system of the present invention loaded onto the client software of Anesthesiologist Workstation 110. In this scenario, a heart patient has arrived within the ICU from surgery and the patient's vital statistics are being monitored. Omitted from this event monitoring process are the dynamic (modality-supplied) respiratory data, though these could certainly be fed into the system and analyzed. This data is stored via the Data Server 106 into Repository 101 by patient in tables established to hold the post-operative respiratory data.

It is important to note that a particular advantage of the system of the present invention is in its ability to select data from a particular patient and from across all available “tiers” (that is, measured from any point in the treatment process) and to correlate those data for study and decision support. Once data are correlated (that is, linked), a model can be built (a relationship can be hypothesized from the plots of the data objects) that can then be stored in Repository 101 and recalled for future use or for validating that a particular hypothesis holds true on other patients.

Patient data may be entered at will or by event. Alternatively, medical modalities such as mechanical ventilators, SpO2 monitors, and heart monitors, through their device connections, can be configured so that data can automatically be brought into the database directly.

FIGS. 10(a)-(b) illustrate a Patient Update Page after several entries have been made. As stated previously, the present invention allows a user to build and store mathematical models of data object relationships. These mathematical models can be recalled at-will for decision support and hypothesis testing by staff. In addition, as more data are collected on other patients, the models are refined and expanded, reflecting the broadened range of patient information. One such model could be the expected time for patient re-warming. The patient, being brought from surgery, is re-warmed to attain normal body temperature. Historical information can indicate, based on patients of this size and weight, approximately when to expect a patient to re-warm. Such information is important as patient body temperature correlates to the strength and function of the heart, and, when instances warrant, whether patients being assisted by mechanical ventilation can be weaned from respiratory support.

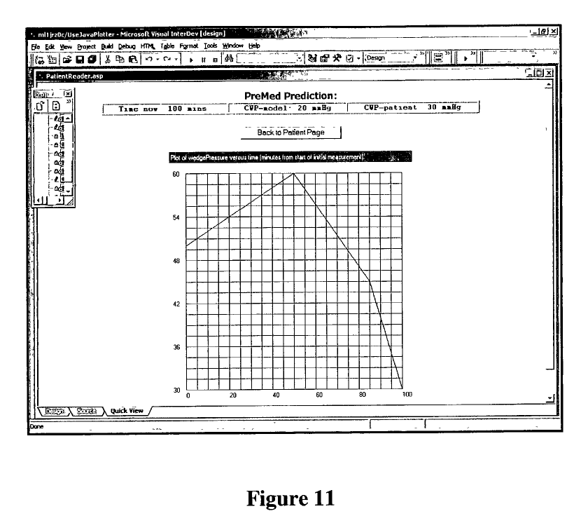

Another model could provide an indicator of patient cardiovascular heart failure, as demonstrated through combined knowledge of CWP, SV, and HR. FIG. 10(b) illustrates the time to re-warm to normal body temperature and provides an assessment of cardiac index. As can also be seen from FIG. 10(b), the present invention is capable of providing the clinician with view real-time plots of these parameters. For example, by selecting “Plot Wedge Pressure”, the clinician is presented with the screen shown in FIG. 11. In addition to visualizing the data, this plot provides a comparison between what abnormal patient CWP would be (expected value) based on the postoperative time and what this patient's value presently is.

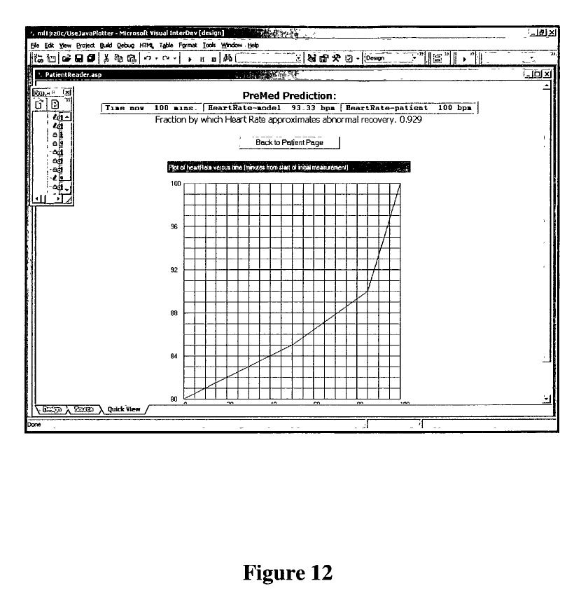

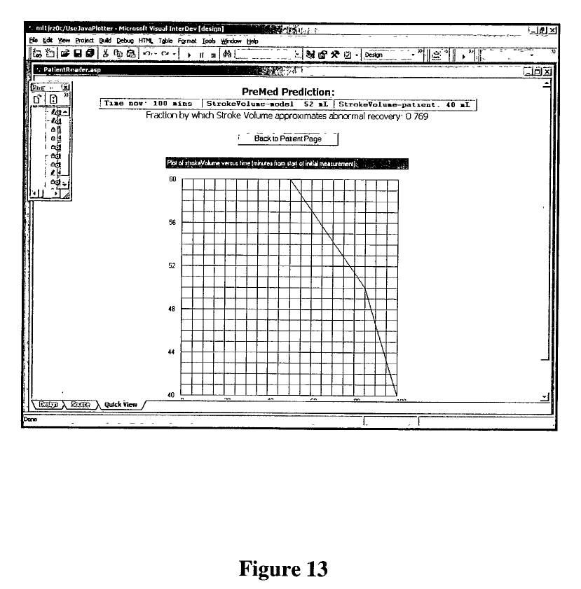

This can be demonstrated for any of the parameters associated with cardiovascular performance. For example, FIG. 12 shows the HR performance for this patient in comparison with historical data from other patients. In the case of HR, there is a high correlation identified between patients experiencing heart failure and this patient's heart rate at this time post-operatively. However, the HR impact must be taken in context with other parameters, such as CWP or SV. The SV plot is shown in FIG. 13.

FIG. 13 shows that the SV is somewhat correlated with those patients who have experienced heart failure post-operatively. So, the HR and SV combined may be an indicator (from the decision support perspective) for the clinician to pay closer attention to this patient in the near term, or to intervene in order to normalize the HR and raise the SV.

The utility of this information is in its ability to enable staff to discern the best approach for treatment of a given patient. This is accomplished by providing staff with comparative data with which to make better informed decisions. For example, one hypothetical question could be “My patient's SV is dropping and HR is increasing. Based on similar patients, how closely correlated is this behavior in other patients in whom heart failure has occurred?” This particular patient's data is then added to the pool of patient data already existing in Repository 101, and can then be used to further refine and update this particular model for future use by another staff member and/or for another patient.

The intent of this one example is to illustrate the process envisioned for the use of the present invention as a decision support tool. The present invention is capable of generating specific patient models by developing of optimal relationships (in the mathematical sense) between one parameter and another through the system's ability to automatically store and provide the tools for associating parameters, which are then stored as mathematical models (a knowledge base) that are then available for future comparison. The present invention also has the significant advantage over the prior art that as more data is recorded, it is used to refine the mathematical models used for prediction.

The above example can be extended to address the following types of hypothetical questions that can be used to support patient care management and general clinical decision support. The example just described provides a clinical presentation relative to an acute care environment. Other, non-acute examples, include the following two scenarios: Management of prime disease patients (chronic and/or home health care); and Identification of patients most likely to benefit from specific treatments.

For example, a clinician or staff member may ask, “I have a database of a thousand patients with the following presentation. How will Mrs. X do?” In this case, the staff member wishes to establish where in the pool of normal patients a particular patient will reside clinically. Again, from the patient care perspective, it is important to be able to leverage off of past knowledge in a way that will help to improve the care of a particular patient.

In other words, addressing the question “I have this many clinical resources to apply to patients in my care. Where are those patients who will benefit most?” In this example, a clinician or staff member has a limited number of available staff to allocate to patients (for example, home health care). The clinician is searching to apply those limited resources wisely so that the largest quantity of patients can be helped.

A feature of the present invention is its ability to develop (or generate) patterns from raw data. These patterns form usable models to clinicians and staff in order to treat their patients. The above examples provide some specific instances, with detailed descriptions, of how the present invention would be instantiated in a particular institution. In an alternative preferred embodiment, the present invention could also be expanded to encompass many institutions, so that data could be pooled, and patterns stored, on a number of patient classes.

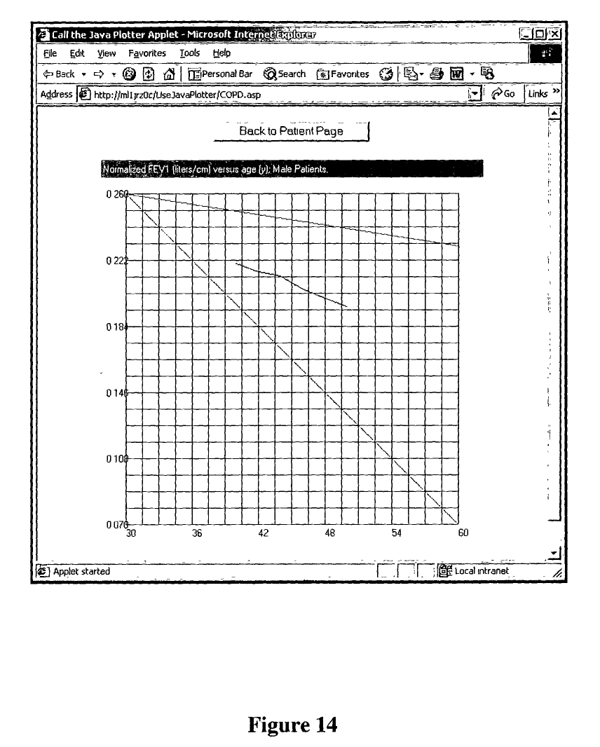

Another example of the predictive use of the system of the present invention is in long-term patient care management. A very simple, but effective example, is the monitoring of Chronic Obstructive Pulmonary Disorder (COPD) in patients. One of the measurements of the evolution of COPD is forced expiratory volume in 1 second (FEV1). FIG. 14 gives an example of patient historical data for FEV1 plotted against patient age. These data are representative of male patients who are free of COPD (green line) and those who have emphysema (orange line). These data were adapted from Kelley and others. Displayed over the top of this information is a simulation of a specific patient's FEV1 performance from measurements taken over several years.

The historical measurements provide a context for the particular patient's data from the perspective that a clinician can understand quickly and through a visual medium how any one particular patient is evolving over time; whether the patient is worsening, remaining stable, or improving. The historical data also provide a means for estimating the future trajectory of a given patient's disease progression by bringing the power of estimation tools to bear on the patient's data in comparison with the historical data.

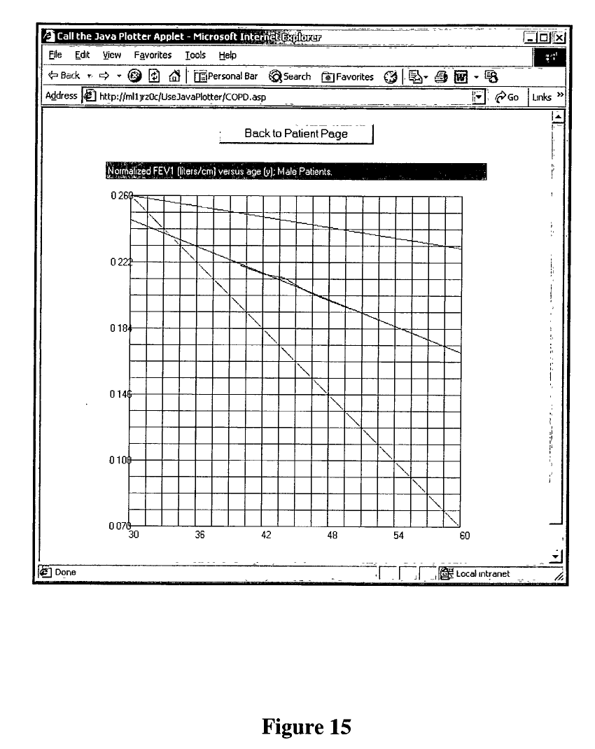

A least-squares overlay of the patient data is presented in FIG. 15, illustrating the expected trajectory over time. This is a tool that can be applied to any data to provide the clinician with a long-term estimate of the expected behavior of a parameter based on its current value. The model of this patient's data is then saved and can be recalled for future comparisons with either this patient or other patients to determine whether changes have occurred or to establish associations between one specific patient's behavior and a population.

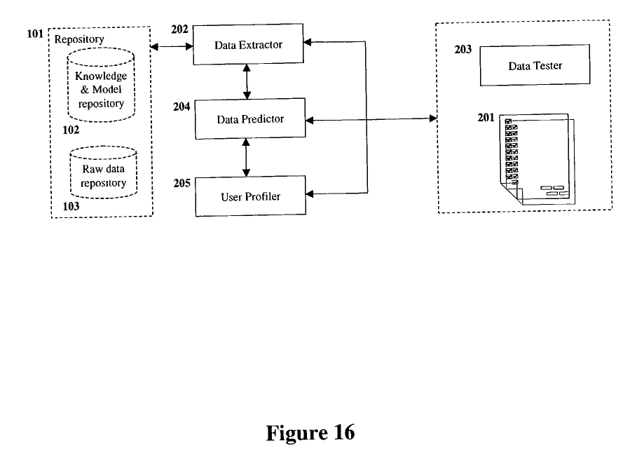

The software processes used to achieve the above-described analysis are preferably embodied in five applications or components, although certainly not limited thereto, as shown in FIG. 16. These applications may reside on Application Server 104, Data Server 106, Web Server 113, User Devices 107, or elsewhere. As shown in FIG. 16, the first of these is a client-side, active or java-server-page (ASP/JSP) based application or Form 201 that is capable of interfacing a with conventional software system so that a user can perform data mining and trending from a variety of User Devices 107, such as laptop 108, desktop computer 109, or other devices, such as a personal digital assistant (not shown). The data can then be published remotely over standard phone lines via wired or wireless modem.

The second software process is preferably server-side Data Extractor 202, which is programmed to retrieve selected data from Repository 101 and disseminate subsets of historical data to the client-side application that provides for “what-if” trending and tracking of data. Data is preferably provided and stored at the user device first. This has the advantage that it decouples the client side application (such as a client-side applet) from Repository 101, and overcomes security issues associated with client applications communicating with server-side data stores.

The third application is preferably a client-side statistical reporting and real-time hypothesis testing capability (in which a user can actively specify thresholds and determine significance of specific data based both on historical outcome and on a patient), Data Tester 203; while the fourth application is preferably a server-side predictive application, Data Predictor 204, responsible for estimating signal frequencies from user models. And, the last process is preferably a server-side profiling application, User Profiler 205, to retain user information for later extraction and personalization.

An important aspect of healthcare is meeting the patient's needs. An important relationship is that between the patient and his or her care providers. Any tool or aid that improves the efficiency of that relationship or speed of treatment adds value. While conventional tools in the systems of the prior art provide various ways to visualize or integrate data, the present invention has the significant advantage over these systems that it is capable of bringing together different sources and assist the care provider in effective decision making for the patient.

Although this invention has been described with reference to particular embodiments, it will be appreciated that many variations may be resorted to without departing from the spirit and scope of this invention as set forth in the appended claims. For example, the embodiments disclosed herein incorporate a separate application server, data server, and Web server, while one of ordinary skill in the art will appreciate that any number of, or only one, computer system is actually necessary to achieve the invention. Similarly, the software of the present invention can comprise a single application having individual components or a suite of applications, and its form is not particularly limited.

What is claimed is:

1. A system for supporting clinical decision-making based on acquired patient data, comprising:
a data repository for storing accumulated medical information associated with a plurality of medical conditions and at least a portion of said acquired patient data;
a data analyzer for identifying a pattern in said acquired patient data based upon at least a portion of said acquired patient data and said accumulated medical information; and
a user interface for transmitting said identified pattern to a user.

2. The system of claim 1, wherein said pattern is stored in said data repository and said data analyzer is programmed to use said stored pattern in identifying another pattern.

3. The system of claim 1, further comprising a peripheral data interface for receiving patient clinical information, said clinical information forming part of said acquired patient data.

4. The system of claim 3, wherein said peripheral data interface receives said clinical information from one or more selected from the group consisting of an anesthesiologist workstation, a laboratory workstation, and medical machinery.

5. The system of claim 1, wherein said data analyzer is further programmed to select a portion of a signal incorporating said acquired patient data in response to a user command; wherein said data analyzer uses said selected signal portion in predicting said pattern.

6. The system of claim 5, wherein said selected signal portion exhibits an anomaly in said acquired patient data.

7. The system of claim 1, wherein said acquired patient data comprises one or more selected from the group consisting of (a) Electro-Cardiogram (ECG) signal data, (b) patient core temperature data, (c) hemodynamic data, (d) respiratory parameter data and (e) medical condition data.

8. The system of claim 7, wherein said respiratory parameter data comprises at least one of, (i) respiratory rate, (ii) respiratory tidal volume, (iii) inspired oxygen fraction and (iv) positive end expiratory pressure.

9. The system of claim 1, wherein said data repository is collated according to patient type characteristics including at least one of (a) patient gender, (b) patient mass, (c) patient body surface area and (d) patient age.

10. The system of claim 1, wherein said data analyzer is programmed to predict said pattern by generating a mathematical model using at least a portion of said acquired medical data and said accumulated medical information.

11. The system of claim 10, wherein said mathematical model comprises a best-fit representation of said pattern.

12. The system of claim 11, wherein said best-fit representation is achieved using least squares regression.

13. The system of claim 1, wherein said data analyzer is programmed to predict said pattern using a probabilistic neural network incorporating at least a portion of said acquired medical data and said accumulated medical information.

14. A computer program for supporting clinical decision-making based on acquired patient data comprising:
a data extractor programmed to receive said acquired patient data and accumulated medical information associated with a plurality of medical conditions; and
a data predictor programmed to identify a pattern in said acquired patient data based upon at least a portion of said acquired patient data and said accumulated medical information and to transmit said identified pattern to a user.

15. The computer program of claim 14, wherein said data extractor is programmed to store said pattern in a data repository and said data predictor is programmed to use said stored pattern in identifying another pattern.

17. The computer program of claim 14, wherein said data predictor is programmed to select a portion of a signal incorporating said acquired patient data in response to a user command; wherein said data predictor uses said selected signal portion in identifying said pattern.

18. The computer program of claim 17, wherein said data predictor is programmed to predict said pattern by generating a mathematical model using at least a portion of said acquired medical data and said accumulated medical information.

19. The computer program of claim 17, wherein said mathematical model comprises a best-fit representation of said pattern using least squares regression.

20. The computer program of claim 18, wherein said data predictor is programmed to predict said pattern using a probabilistic neural network incorporating at least a portion of said acquired medical data and said accumulated medical information.

21. The computer program of claim 14, further comprising a user profiler programmed to receive and store user information for later extraction and personalization.

22. A method of using a computer system to support clinical decision-making based on acquired patient data comprising the steps of:
receiving accumulated medical information associated with a plurality of medical conditions and at least a portion of said acquired patient data onto a computer system;
analyzing at least a portion of said acquired patient data and said accumulated medical information using said computer system to predict a pattern therein by generating a mathematical model; and
transmitting said identified pattern to a user using said computer system.

23. The method of claim 21, wherein said acquired patient data includes patient clinical information.

24. The method of claim 22, wherein said clinical information is received from one or more selected from the group consisting of an anesthesiologist workstation, a laboratory workstation, and medical machinery.

25. The method of claim 22, further comprising the steps of selecting a portion of a signal incorporating said acquired patient data in response to a user command; and using said selected signal portion in predicting said pattern.

26. The method of claim 25, wherein said selected signal portion exhibits an anomaly in said acquired patient data.

27. The method of claim 23, wherein said patient clinical information comprises one or more selected from the group consisting of (a) Electro-Cardiogram (ECG) signal data, (b) patient core temperature data, (c) hemodynamic data, (d) respiratory parameter data and (e) medical condition data.

28. The method of claim 27, wherein said respiratory parameter data comprises at least one of, (i) respiratory rate, (ii) respiratory tidal volume, (iii) inspired oxygen fraction and (iv) positive end expiratory pressure.

29. The method of claim 22, further comprising the step of collating said acquired patient data according to patient type characteristics including at least one of (a) patient gender, (b) patient mass, (c) patient body surface area and (d) patient age.

30. The method of claim 22, wherein said mathematical model comprises a best-fit representation of said pattern in a particular medical parameter for a particular patient type.

31. The method of claim 30, wherein said best-fit representation is achieved using least squares regression.

32. The method of claim 22, wherein said pattern is predicted using a probabilistic neural network incorporating at least a portion of said acquired medical data and said accumulated medical information.
